(19) United States
(12) Patent Application Publication
(10) Pub. No.: US 2005/0172091 A1
(43) Pub. Date: Aug. 4, 2005

(54) Method and an apparatus for interleaving read data return in a packetized interconnect to memory

(76) Inventors: Hemant G. Rotithor, Hillsboro, OR (US); An-Chow Lai, Hillsboro, OR (US); Randy B. Osborne, Beaverton, OR (US); Olivier C. Maquelin, Beaverton, OR (US); Mladenko Vukic, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/769,201

(22) Filed: Jan. 29, 2004

(51) Int. Cl. G06F 12/00

(52) U.S. Cl. 711/157; 711/168; 711/118

(57) ABSTRACT

A method and an apparatus to process read data return has been disclosed. In one embodiment, the method includes packing a cache line of each of a number of read data returns into one or more packets, splitting each of the one or more packets into a plurality of flits, and interleaving the plurality of flits of each of the plurality of read data returns. Other embodiments are described and claimed.

### FIELD OF INVENTION

The present invention relates to computer systems, and more particularly, to routing read data return in a computer.

### BACKGROUND

In a typical computer system, memory page misses incur a high latency in returning data in response to read requests. Interleaved memory channels can process back to back memory page misses in parallel and overlap the latency from the two page misses over a longer burst length. In comparison, lock step memory channels process page misses sequentially over shorter burst length. Interleaved memory channels thus have higher efficiency of handling access patterns with many page misses than lock step memory channels. In general, applications that have a significant number of page misses perform better with interleaved memory channels.

Typically, each interleaved channel independently processes a read request and returns read data using half the peak memory system bandwidth. A read request, also known as a read, commonly causes a cache line of data to be returned from the memory. Returning read data at half memory system bandwidth implies that the latency to return the last byte in the cache line is higher compared to the case in which the cache line is returned from two channels in lock step. When access patterns have many memory page hits, interleaved channel memory performance degrades if the read requests sent to the interleaved channels are not well balanced.

A software program may make a read request from a central processing unit (CPU) for different data sizes starting at the granularity of a byte. If the data requested is not in the CPU cache, the read request is sent to the memory to retrieve the data. Although, the original read may request data in a certain unit smaller than a cache line, such as, for example, a byte, a word, a double word, etc., the CPU retrieves a cache line of data from the memory in response to the read request because of locality of spatial references. The size of a cache line varies from system to system, e.g., 64 bytes, 128 bytes, etc. The cache line of data is handled in the CPU core at the granularity of a chunk, which is smaller than the cache line size, which may be 8 bytes, 16 bytes, etc. The data that the application program originally requested is contained in one of the chunks of the cache line called the critical chunk. A read request stalls in the CPU for the critical chunk, and therefore, reducing the latency of the critical chunk improves the performance of the system. To reduce the latency of the critical chunk, the memory system returns the critical chunk in a cache line first in the stream of bytes returned in response to a read request. Furthermore, reducing latency of the non-critical chunks of the cache line may improve performance for some applications because the CPU core may have other requests that ask for the other data bytes in the cache line.

Cache lines returned in response to the read requests are typically sent via an interconnect from a memory controller to the CPU. A packetized interconnect sends packets of messages containing information over a link layer and a physical layer. Packets emitted by the CPU contain requests to the memory and cache line data for write requests. Packets received by the CPU include read responses containing cache line data. At the link layer, a packet may be organized into equal sized flits for efficient transmission. A flit is the granularity at which the link layer of the packetized interconnect sends data.

Currently, data from interleaved memory channels is sent via a shared front side bus (FSB) to the CPU, such as a P4FSB. On the shared FSB, read data return may be sent as soon as it becomes available from a memory channel and the transfer may be interrupted by inserting wait states until more chunks of data become available. This technique reduces the latency to the critical chunk of the cache line if not all the read data return is available, or is available at lower bandwidth than the FSB can deliver. Currently, the P4FSB protocol allows data received in response to only one read request to be returned at any given time, and thus, cache lines corresponding to two read requests simultaneously returning from two memory channels are sent sequentially.

On a packetized interconnect, a cache line of read data is stored and forwarded as illustrated in FIGS. 1A and 1B. In response to a read request, chunks of data of the read return are stored temporarily in a buffer. In this application the read returns are assumed to be stored in a FIFO buffer in order of return from the memory controller and top of the read return queue means the head of this FIFO, or oldest pending read return. Once enough chunks of data of a cache line have accumulated, a header and the chunks are sent in a stream to the CPU in a packet without interruption. The header is sent contiguously with the packet. Store and forwarding is necessary to send cache line data in one packet. Although chunks of a second cache line may be available from another memory channel, the chunks of the second cache line are not sent until all the chunks of the first cache line have been sent.

The above practice is a simple, but is a low performance, option because there is a store and forward delay in sending the critical chunk after it is received from the memory channel as the critical chunk sits in the read return buffer. Furthermore, simultaneously arriving read returns are serialized on the interconnect by buffering the read returns immediately following the first one. Thus, there is additional delay in sending these read returns. As a result, a larger overall latency is incurred.

### BRIEF DESCRIPTION OF THE DRAWINGS

The present invention will be understood from the detailed description that follows and from the accompanying drawings, which however, should not be taken to limit the appended claims to the specific embodiments shown, but are for explanation and understanding only.

FIG. 1A shows a flow diagram of a prior art process for forwarding data in response to a read request.

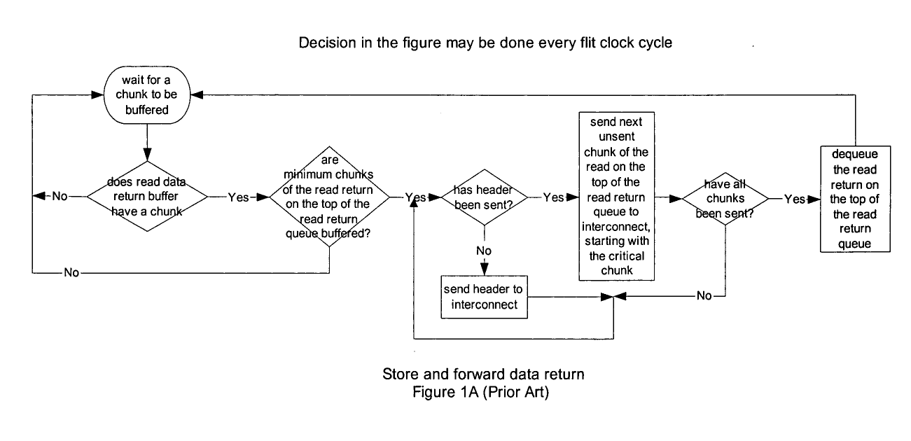

FIG. 1B shows a timing diagram of an example of data transfer according to store-and-forward.

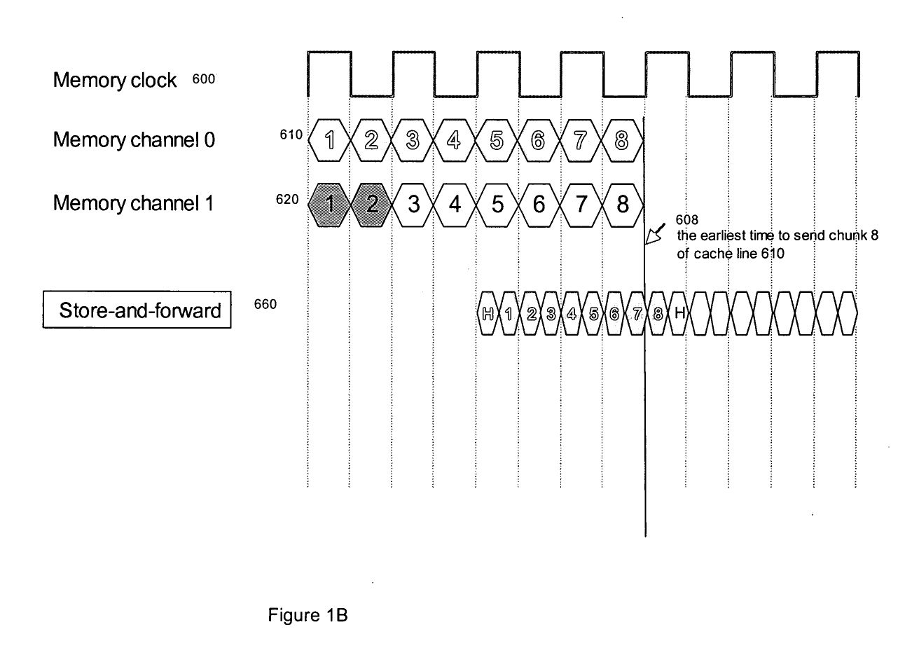

FIG. 2 shows an exemplary embodiment of a computer system.

FIG. 3A shows a flow diagram describing one embodiment of a process for forwarding data in response to read requests.

FIG. 3B illustrates an example of data transfer according to one embodiment of critical chunk with bubble.

FIG. 4A shows a flow diagram describing one embodiment of a process for forwarding data in response to read requests.

FIG. 4B illustrates an example of data transfer according to one embodiment of critical chunk interleaving.

FIG. 5A shows a flow diagram describing one embodiment of a process for forwarding data in response to read requests.

FIG. 5B illustrates an example of data transfer according to one embodiment of flit-level interleaving.

FIG. 5C illustrates another example of data transfer according to one embodiment of flit-level interleaving.

FIG. 6A shows the logical representation of an embodiment of a memory controller hub performing flit-level interleaving.

FIG. 6B illustrates one example of data transfer according to one embodiment of flit-level interleaving.

FIG. 6C illustrates another example of data transfer according to one embodiment of flit-level interleaving.

FIG. 6D illustrates another example of data transfer according to one embodiment of flit-level interleaving.

### DETAILED DESCRIPTION

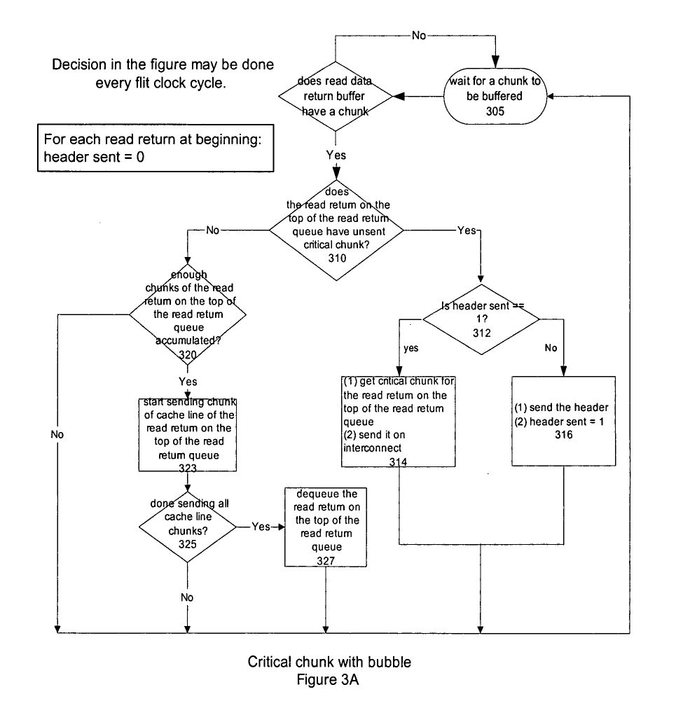

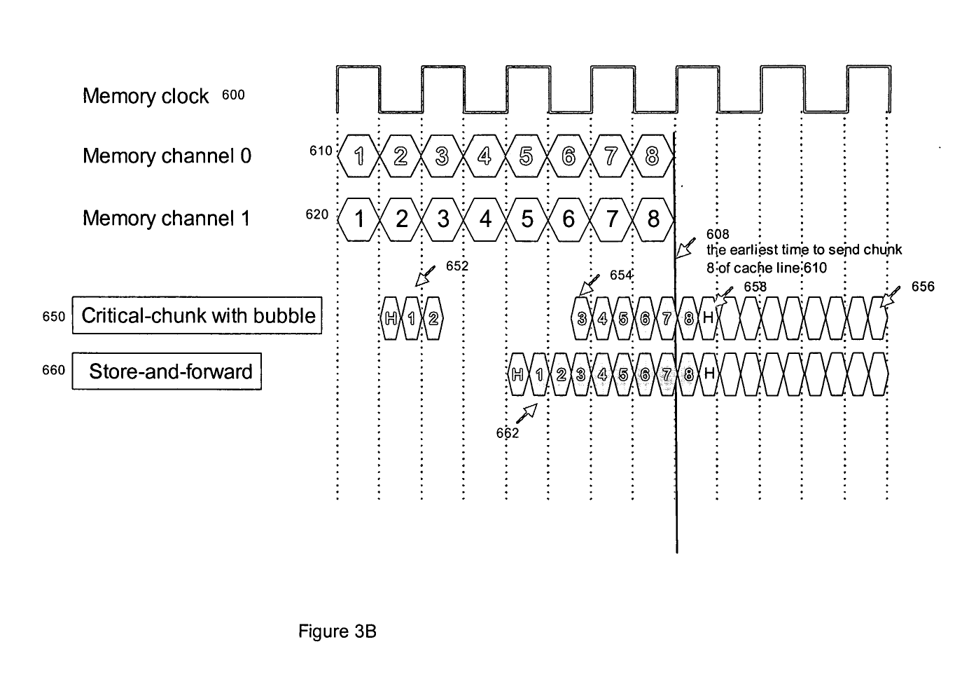

A method and an apparatus to process read data return is described. In one embodiment, chunks of a first cache line and a second cache line are interleaved. Each cache line has a critical chunk. The critical chunks of the first and second cache lines appear in an interleaved stream before the non-critical chunks of the first and second cache lines. The interleaved chunks of the first and second cache lines are sent via a packetized interconnect to a processor. Some examples of data transfer according to various embodiments of the present invention are shown in FIGS. 3B, 4B, 5B, 5C, 6B, 6C, and 6D, and details of which are described below.

In the following description, numerous specific details are set forth. However, it is understood that embodiments of the invention may be practiced without these specific details. In other instances, well-known circuits, structures, and techniques have not been shown in detail in order not to obscure the understanding of this description. Furthermore, references to “one embodiment” in the current description may or may not be directed to the same embodiment.

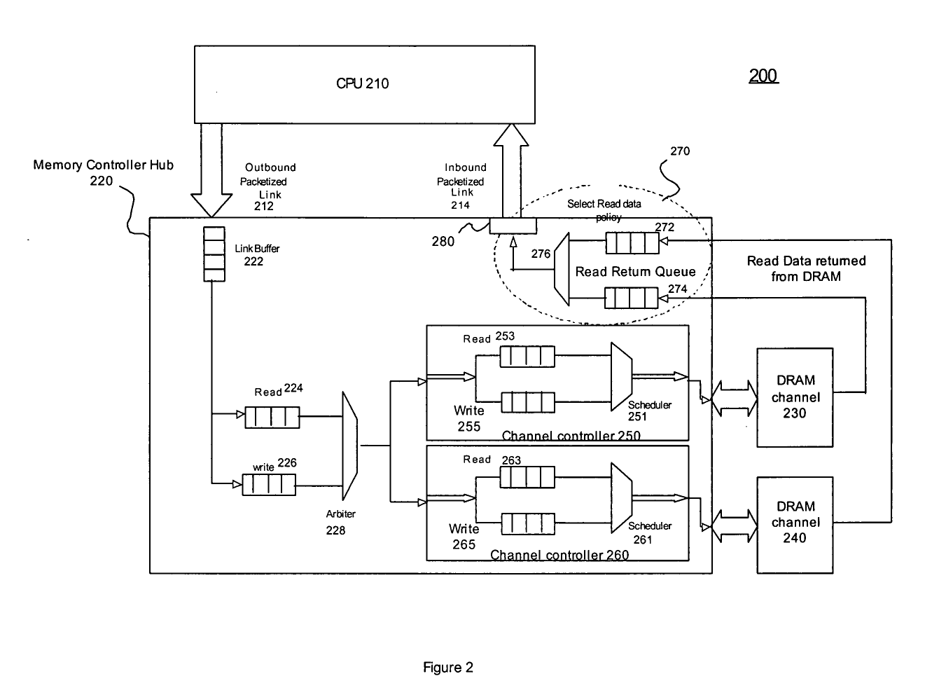

FIG. 2 shows an exemplary embodiment of a computer system 200. One should appreciate that different embodiments of the system may include additional components not shown in FIG. 2. System 200 includes a CPU 210, a memory controller hub (MCH) 220, and two dynamic random access memory (DRAM) channels 230 and 240. In one embodiment, the DRAM channels 230 and 240 are coupled to a number of DRAM devices (not shown). One should appreciate that other types of memory and memory channels may be used in various embodiments, such as, for example, synchronous DRAM (SDRAM), double data rate (DDR) SDRAM, etc.

The CPU 210 and the DRAM channels 230 and 240 are coupled to the MCH 220. In one embodiment, the CPU 210 is coupled to the MCH 220 by an outbound packetized link 212 and an inbound packetized link 214. In response to a read request in a program being executed by the CPU 210, the CPU 210 sends a read request via the outbound packetized link 212 to the MCH 220. In response to the request, the MCH 220 retrieves data from one of the DRAM channels 230 and 240. In one embodiment, the data is returned as a cache line. The MCH 220 returns the data to the CPU 210 via the inbound packetized link 214 as described in more details below.

In one embodiment, the cache line has a size of 64 bytes. The cache line may be split into a number of chunks. For example, in one embodiment, a cache line of 64 bytes is split into 8 chunks, each chunk having 8 bytes. However, one should appreciate that the chunk size varies in different systems. The cache line returned may include data in addition to what is actually requested by the program because the data requested by the program may be less than a cache line, such as, for example, a byte, or a word. The chunk containing the data actually requested is referred to as a critical chunk.

In one embodiment, the data is sent in packets on the inbound packetized link 214 in units at the granularity of a flit. A flit is the granularity at which link layer of the packetized interconnect sends data. The flit is a non-interruptible unit of data sent on a communication medium between the CPU 210 and the interconnect 214. The size of the flit varies among different embodiments, for example, a flit size may be 8 or 4 bytes. A chunk may be sent in one or more flits. One should appreciate that the flit size may or may not be the same as the chunk size. Furthermore, the time to send a flit depends on the link speed and link width. In one embodiment, a read or write request packet is sent in one flit, while a read or write cache line data packet is sent in multiple flits.

Referring to FIG. 2, the MCH 220 includes a link buffer 222, a read buffer 224, a write buffer 226, an arbiter 228 that arbitrates between reads and writes, two channel controllers 250 and 260, read data return circuitry 270, and a packetized interconnect interface 280. In one embodiment, the circuitry 270 includes two read return buffers 272 and 274 and a multiplexer 276. A request from the CPU 210 is forwarded to the MCH 220 via the outbound packetized link 212 and is temporarily held in the link buffer 222. The request may be a read request or a write request. The read request is forwarded to the read buffer 224 to be input to the arbiter 228. Likewise, the write request is forwarded to the write buffer 226 to be input to the arbiter 228. The arbiter 228 forwards either the read request or the write request to one of the channel controllers 250 and 260, based on some mapping functions.

The channel controllers 250 and 260 are coupled to the DRAM channels 230 and 240 respectively. In one embodiment, each DRAM channel has a dedicated channel controller. In an alternate embodiment, a channel controller handles multiple DRAM channels. A read request for data from the DRAM channel 230 is forwarded from the arbiter 228 via the channel controller 250 to the DRAM channel 230. In response to the read request, the DRAM channel 230 returns a cache line of data to the MCH 220 via the circuitry 270. Likewise, a read request for data from the DRAM channel 240 is forwarded via the channel controller 260 to the DRAM channel 240. In response to the read request, the DRAM channel 240 returns a cache line of data to the circuitry 270.

Referring to FIG. 2, the circuitry 270 includes two read return buffers 272 and 274 and a multiplexer 276. The chunks of data returned from the DRAM channels 230 and 240 are forwarded to the read return buffers 274 and 272 respectively. Alternatively, instead of two buffers 274 and 272, a single buffer may be used to buffer both data returned from the DRAM channel 230 and the DRAM channel 240. Referring to FIG. 2, the read return buffers 272 and 274 are coupled to the inputs of the multiplexer 276. In one embodiment, the multiplexer 276 selects data a flit at a time from either of the read return buffers 272 and 274 and outputs the selected data. The packetized interconnect interface 280 outputs the selected chunks to the CPU 210 via the inbound packetized link 214.

In one embodiment, the channel controllers 250 and 260 are substantially identical. Referring to FIG. 2, the channel controller 250 includes a scheduler 251, a read buffer 253, and a write buffer 255 which may be shared between the channels. Similarly, the channel controller 260 includes a scheduler 261, a read buffer 263, and a write buffer 265. The read buffers 253 and 263 store read requests temporarily and input the read requests to the schedulers 251 and 261 respectively. Likewise, the write buffers 255 and 265 store write requests temporarily and input the write requests to the schedulers 251 and 261 respectively. The schedulers 251 and 261 schedule transmission of read requests and write requests to the DRAM channel 230 and the DRAM channel 240 respectively.

In one embodiment, the packetized interconnect 214 runs faster than the DRAM channels 230 and 240. For example, the interconnect 214 may run on an interconnect packet clock frequency that delivers a bandwidth of 10.6 GB/s in each direction while each of the DRAM channels 230 and 240 runs at a clock frequency that delivers a bandwidth of 5.3 GB/s. Therefore, the packetized interconnect 214 may send data faster than receiving data from either of the DRAM channels 230 and 240. As a result, there may be a mismatch between the rate at which chunks are produced and the rate at which the chunks are consumed. Such a mismatch is not desirable if the data is to be sent in a contiguous packet. However, embodiments of the present invention take advantage of this mismatch to send data efficiently. Three exemplary embodiments are described in details below.

Critical Chunk with Bubble

One exemplary embodiment of a process for forwarding read return data is referred to as critical chunk with bubble, which includes sending a critical chunk when the critical chunk becomes available, storing the non-critical chunks, and sending the non-critical chunks in another packet. FIG. 3A shows a flow diagram of one exemplary embodiment of critical chunk with bubble and FIG. 3B illustrates an example of data transfer according to the critical chunk with bubble. The process is performed by processing logic that may comprise hardware (e.g., circuitry, dedicated logic, etc.), software (such as is run on a general purpose computer system or a dedicated machine), or a combination of both. Processing logic buffers a chunk of data from a storage device, such as, for example, one of the DRAM channels 230 and 240 in FIG. 2 (processing block 305). Then processing logic checks whether the read return on the top of a read return queue has any critical chunk not yet forwarded to the CPU 210 (processing block 310). If the cache line of the read on top of the read return queue has a critical chunk not yet forwarded, then processing logic checks whether a header has been sent (processing block 312). If the header has been sent, processing logic gets the critical chunk for the read return on the top of the read return queue and sends the critical chunk on the interconnect (processing block 314). Otherwise, processing logic sends the header and sets the flag “header sent” to 1 (processing block 316). Processing logic then repeats processing block 305. One should appreciate that the oldest read, which is a request for data coming into MCH 220, may not correspond to the read return at the top of the read return queue from the MCH 220. In other words, the read requests and read returns may be in different orders.

If the critical chunk of the cache line of the oldest read return has been forwarded, then processing logic checks whether enough chunks of the read return on the top of the read return queue have accumulated (processing block 320). If there are enough chunks accumulated, then processing logic starts sending chunks of the cache line of the read return on the top of the read return queue onto the interconnect (processing block 323). In one embodiment, processing logic waits until all non-critical chunks of the read at the top of the read return queue have accumulated to send the chunks via the interconnect in a single transfer without interruption. Processing logic checks whether all the chunks of the cache line of the read at the top of the return queue have been sent (processing block 325). If not, then processing logic repeats processing block 305. Otherwise, processing logic removes the read return on the top of the read return queue from the queue (processing block 327). Processing logic then repeats processing block 305.

Referring to FIG. 3B, two exemplary cache lines 610 and 620 corresponding to two read returns that arrive in an overlapping manner via two memory channels from two storage devices, such as, for example, the DRAM channels 230 and 240 in FIG. 2. The example 650 illustrates a stream of chunks in the critical chunk with bubble scheme. The memory clock 600 is shown above the read returns 610 and 620. For the purpose of illustration, the following discussion assumes that the memory clock 600 in FIG. 3B is at 333 MHz (for a two-channel DDR2 667) and the frequency of the flit clock is 1333 MHz. Suppose the cache line 610 is the data for the read at the top of the read return queue of read returns in the current example. The critical chunks 652 of the cache line 610 are forwarded when the critical chunks 652 become available. The rest of the cache line 610 is stored and not forwarded to the interconnect 214 (referring to FIG. 2) until 654, at which time the remaining cache line can be streamed to the interconnect 214 in one packet without interruption. Referring to FIG. 3B, the earliest time to deliver the third chunk of the exemplary cache line 610 is substantially equal to the time at 608 minus 6 interconnect cycles so that there is no bubble when the rest of the cache line 610 is transferred on the interconnect. The data 656 including the second cache line 620 and a header 658 is forwarded after the transmission of the data 654 of the cache line 610 has been completed. In one embodiment, the time gap between sending the flits 652 and the flits 654 is used to send the flits of a prefetched cache line of another read data return in order to increase the overall efficiency and performance of the system. The prefetched cache line may be a result of the read in 214 (referring to FIG. 2) hitting an address in the write buffer 226 and getting its data forwarded or because of a read hitting an address in a prefetch data buffer when the MCH 220 has a chipset prefetcher (not shown).

In one embodiment, two types of packets are defined for transferring the chunks, namely, a critical chunk packet and a cache line packet. By sending a critical chunk when the critical chunk becomes available and storing the rest of the cache line to be forwarded later, the latency to the critical chunk is reduced. For example, referring to FIG. 3B, the critical chunk 652 of the read 610 is sent approximately one and half memory clock cycle earlier than the corresponding critical chunk 662 sent using the store and forward scheme 660. However, the cache line latency and the latency to the other reads in the case of simultaneously arriving reads is still high.

Critical Chunk Interleaving

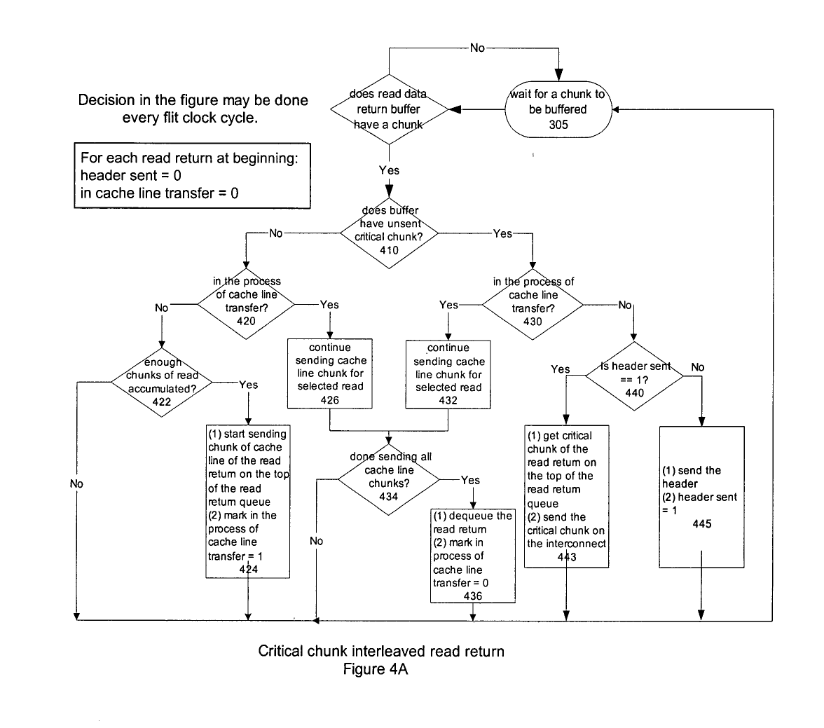

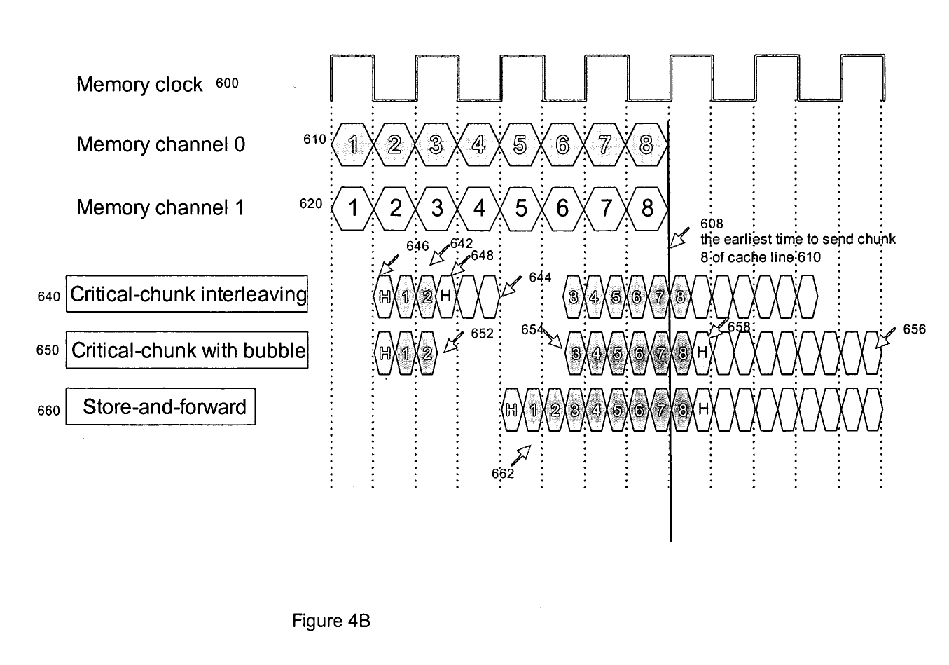

FIG. 4A shows one embodiment of a process for forwarding read return data. This embodiment is hereinafter referred to as critical chunk interleaving. FIG. 4B illustrates an example of data transfer according to one embodiment of critical chunk interleaving. In one embodiment, critical chunk interleaving involves interleaving the critical chunks of the cache lines of two read returns, sending the critical chunks in two separate packets, and sending the rest of each cache line in a separate packet. The process is performed by processing logic that may comprise hardware (e.g., circuitry, dedicated logic, etc.), software (such as is run on a general purpose computer system or a dedicated machine), or a combination of both. Processing logic buffers a chunk of data of a read return from a storage device (processing block 405). Then processing logic checks whether the buffer has any critical chunk not yet forwarded (processing block 410). If the buffer has no critical chunk, then processing logic checks whether another chunk of a cache line is being transferred (processing block 420). If not, then processing logic checks whether enough chunks of data for the read at the top of the read return queue have been accumulated (processing block 422). If there are insufficient chunks accumulated, processing logic continues to wait for more chunks by repeating processing block 405 (processing block 422). If there are sufficient chunks accumulated, then processing logic starts sending the chunks of the cache line of the read return on the top of the read return queue and indicates that processing logic is transferring a cache line (processing block 424). Processing logic then repeats processing block 405. In one embodiment, processing logic delivers the last chunk in the cache line for the read at the top of the read return queue after the last chunk is ready. For example, referring to FIG. 4B, the last chunk of the exemplary cache line 610 is ready at 608.

On the other hand, if the buffer has no unsent critical chunk and processing logic is transferring a cache line, then processing logic continues with the transfer (processing block 426). Processing logic checks whether all the chunks of the cache line for the read have been transferred (processing block 434). If not, processing logic repeats processing block 405 to wait for the rest of the chunks. Otherwise, processing logic removes the read from the queue and indicates that processing logic is not transferring any cache line (processing block 436). Processing logic then repeats processing block 405.

If the buffer has an unsent critical chunk, then processing logic checks whether processing logic is transferring a cache line (processing block 430). If so, then processing logic continues with the transfer (processing block 432). Processing logic then checks whether all chunks of the cache line have been sent (processing block 434). If all chunks have been sent, then processing logic removes the read from the queue and indicates that processing logic is not transferring any cache line (processing block 436). Processing logic then repeats processing block 405.

If the buffer has a critical chunk not sent yet and processing logic is not transferring any cache line, then processing logic checks whether a header has been sent (processing block 440). If the header has been sent, processing logic gets the critical chunk of the read return on the top of the read return queue and sends the critical chunk on an interconnect (processing block 443). In one embodiment, the interconnect is a packetized interconnect. However, if the header has not been sent, processing logic sends the header and sets the flag “header sent” to 1 (processing block 445). Then processing logic repeats processing block 405.

FIG. 4B shows an example of two cache lines 610 and 620 returned in an overlapping manner from two storage devices in response to two read requests. An example of data transfer according to one embodiment of critical chunk interleaving is shown as 640 in FIG. 4B. A header is added to each cache line. For example, the header 646 is added to the cache line from memory channel 0 and the header 648 is added to the cache line from memory channel 1. The critical chunks 642 and 644 of the cache lines 610 and 620 respectively are interleaved. In one embodiment, the critical chunks of two different cache lines are sent in separate packets when they arrive and the remaining chunks of each cache line are sent in two other separate packets. The headers 646 and 648 contain the link level information of the packets transferring the critical chunks 642 and 644 respectively. In one embodiment, the time gap between sending the flits 644 and the non-critical chunks is used to send the flits of a prefetched cache line of another read data return (not shown) in order to increase the overall efficiency and performance of the system.

Furthermore, two packet types may be defined to transfer read return data. In one embodiment, the packet types include a critical chunk packet and a cache line packet. Interleaving the critical chunks of separate read returns reduces the latency to the critical chunks of both reads, and hence, improves the performance of many applications. The latency reduction by critical chunk interleaving can be significant when the cache lines returned from the storage devices have not yet queued up in the MCH 220.

Flit-level Interleaving

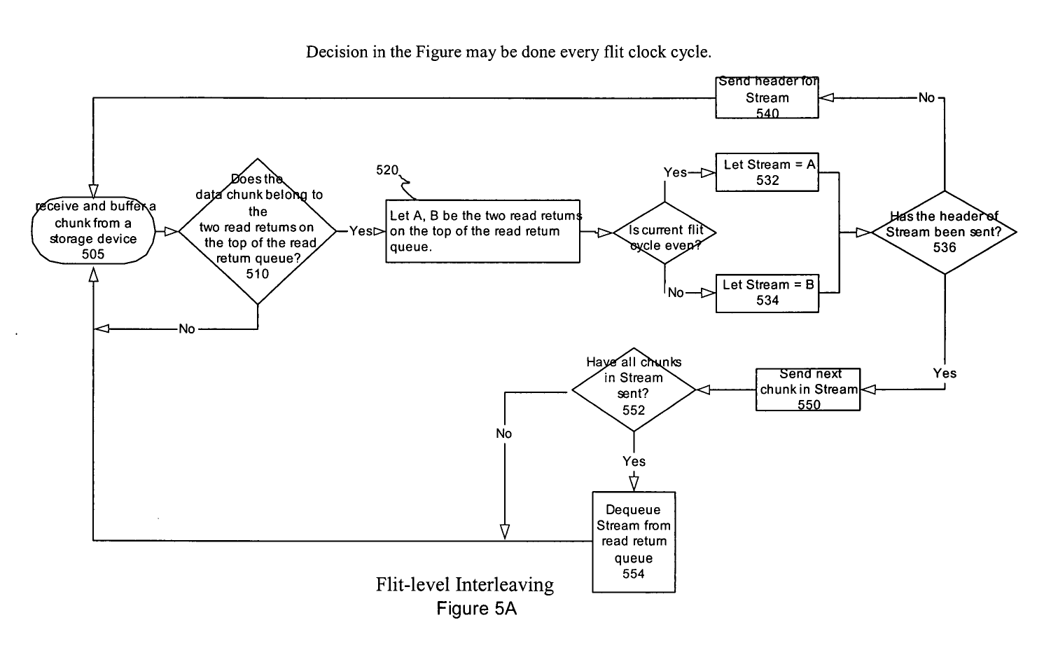

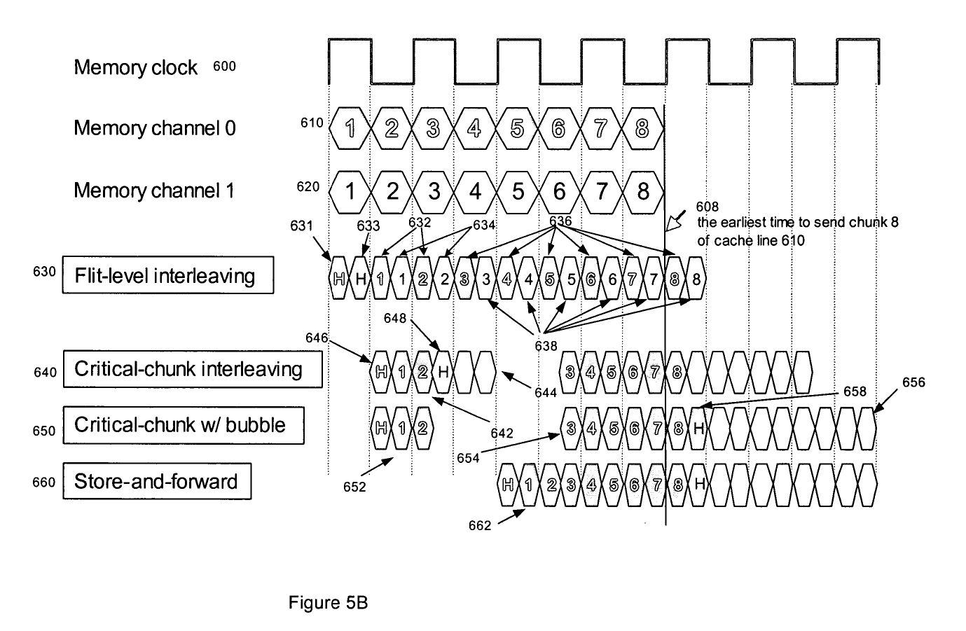

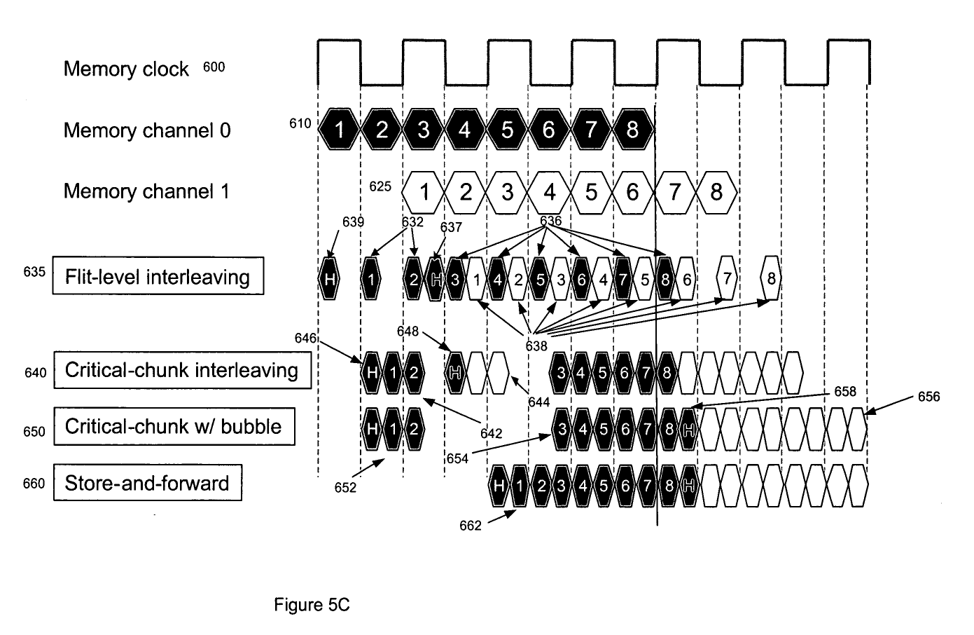

FIG. 5A shows one embodiment of a process for forwarding read return data. This embodiment is hereinafter referred to as flit-level interleaving. In one embodiment, chunks of separate read returns are interleaved and sent as flits on an interconnect. FIGS. 5B and 5C illustrate examples of data transfer according to various embodiments of flit-level interleaving. The process is performed by processing logic that may comprise hardware (e.g., circuitry, dedicated logic, etc.), software (such as is run on a general purpose computer system or a dedicated machine), or a combination of both. Processing logic receives a returning read chunk from a storage device in response to a read (processing block 505). Then processing logic checks whether the data chunk belongs to the two read returns on the top of a read return queue (processing block 510). If not, then processing logic buffers the returning chunk (processing block 505). Otherwise, processing logic initializes A to be the read return on the top of the read return queue and B to be the next read return on the top of the read return queue (processing block 520).

In one embodiment, processing logic assigns Stream to be A if the current flit clock cycle is even (processing block 532). Processing logic assigns Stream to be B, i.e., the second oldest read return, if the current flit clock cycle is odd (processing block 534). Processing logic then checks whether the header of Stream has been sent yet (processing block 536). If not, processing logic sends the header of Stream (processing block 540) and repeats processing block 505. In one embodiment, the header contains link level information of the packet.

If the header of Stream has already been sent, then processing logic sends the next chunk in Stream (processing block 550). Processing logic then checks whether all chunks in Stream have been sent (processing block 552). If not, processing logic repeats processing block 505. Otherwise, processing logic removes Stream from the read return queue before repeating processing block 505 (processing block 554).

FIG. 5B shows an example of an interleaved stream of chunks of two cache lines generated by flit-level interleaving 630. Examples of data transfer according to one embodiment of critical chunk interleaving, one embodiment of critical chunk with bubble, and store-and-forward are illustrated as 640, 650, and 660, respectively, in FIG. 5B. Two cache lines 610 and 620 arrive at the same time from two distinct memory channels in response to two read requests. The flits 632 and 634 containing the critical chunks of the cache lines 610 and 620 respectively are interleaved. Furthermore, two headers 631 and 633 are added, one for each cache line. In addition, the flits 636 and 638 containing the remaining chunks of the two cache lines 610 and 620, respectively, are interleaved to be sent to a processor. In one embodiment, the interleaved flits are sent via an interconnect, which may be a packetized interconnect. It should be apparent to one of ordinary skill in the art that the flits can be sent to the processor via other means. The latency to both cache lines is reduced because the critical chunks and the remaining chunks are forwarded with less delay.

FIG. 5C shows another example of an interleaved stream 635 of flits of two exemplary cache lines 610 and 625 generated by flit-level interleaving. Unlike the cache lines 610 and 620 in FIG. 5B, the cache lines 610 and 625 in FIG. 5C do not arrive at the same time. The cache line 625 arrives later than the cache line 610 and partially overlaps with the cache line 610. The header 639 and the chunks of the cache line 610 in FIG. 5C are still sent at about the same time as that in FIG. 5B. However, there are bubbles of time gaps between the flits containing the header 639 and the first two chunks 632 of the cache line 610 in FIG. 5C because the cache line 625 arrives later than the cache line 610. When the cache line 625 starts to arrive at about the same time as the third chunk of the cache line 610, flits containing the header 637 and the chunks 638 of the cache line 625 are interleaved with the flits 636 containing the rest of the chunks of the cache line 610.

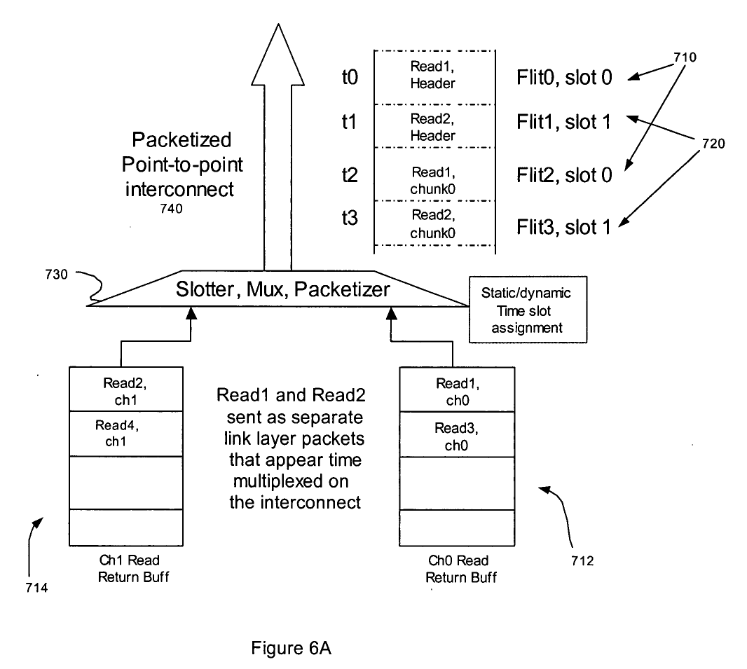

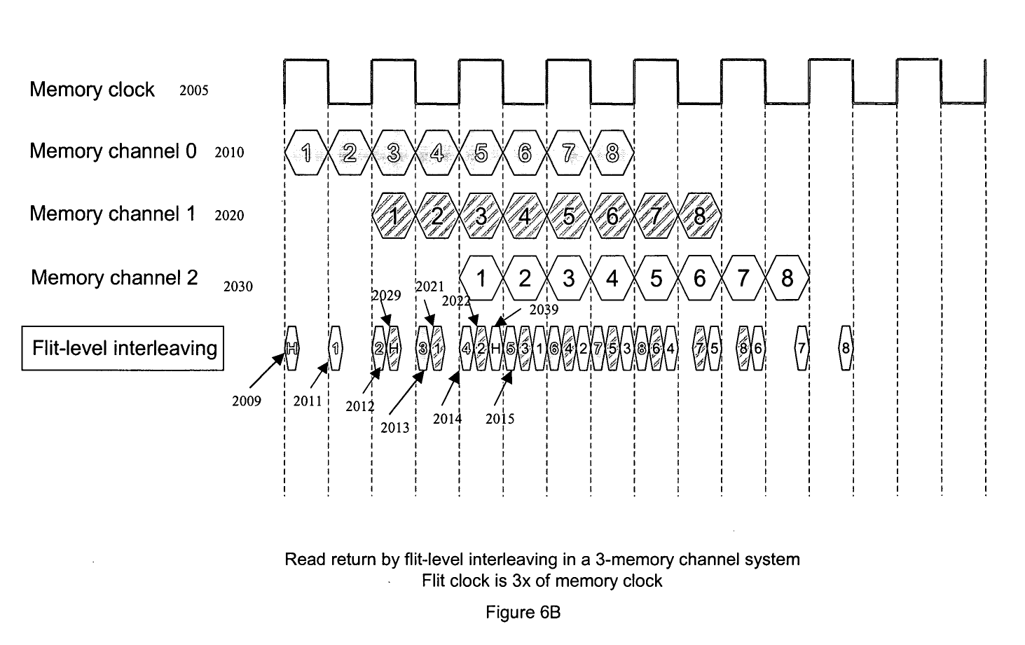

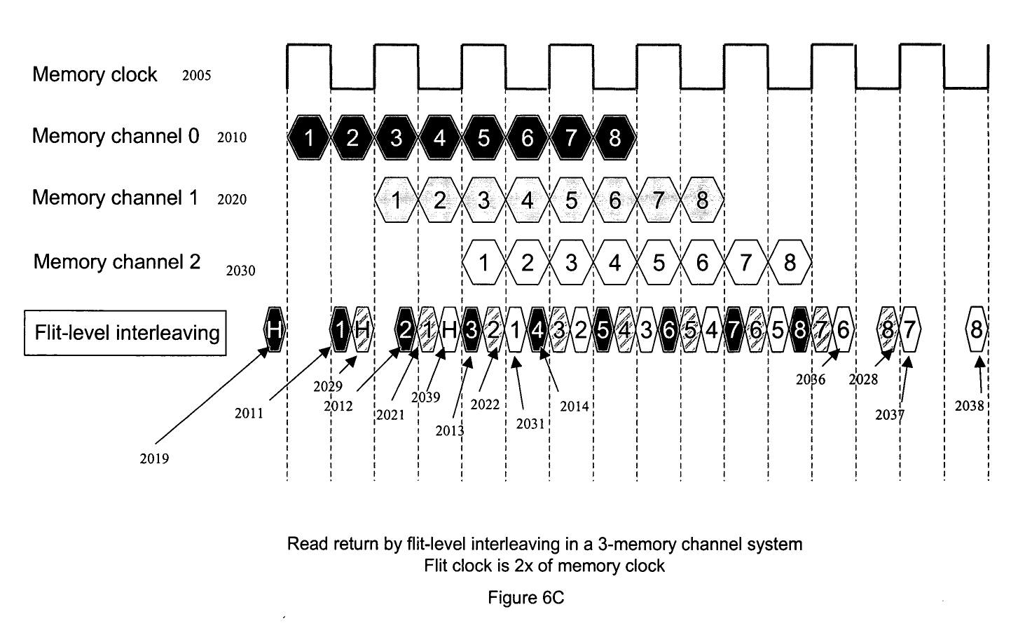

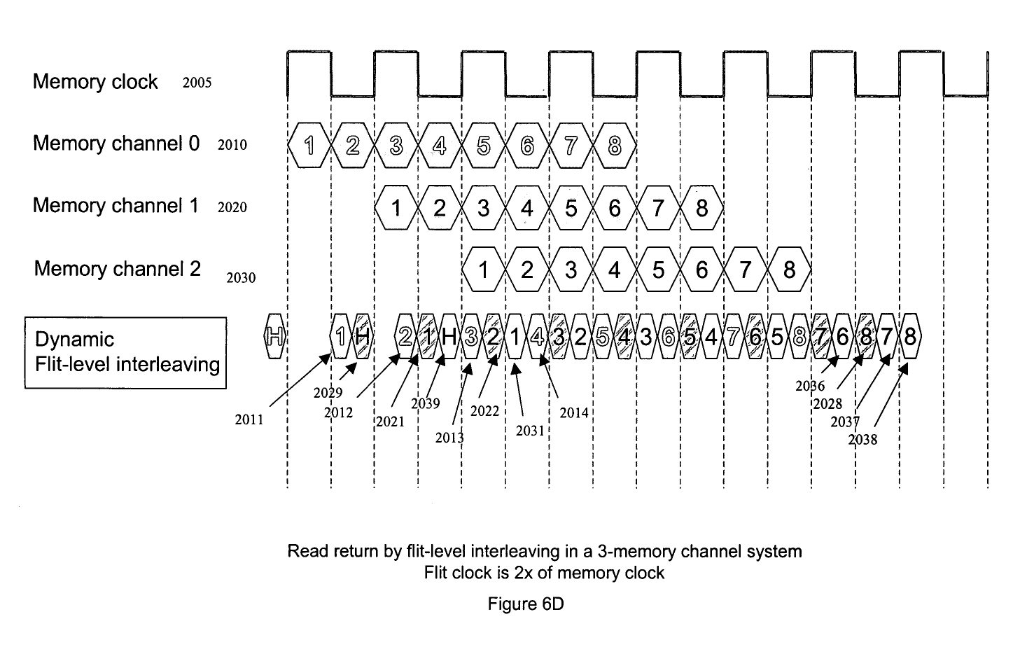

FIG. 6A shows the logical representation of one embodiment of a memory controller hub performing flit-level interleaving. Chunks of data are returned from two storage devices, such as the DRAM channels 230 and 240 in FIG. 2, in response to two separate reads. The chunks are temporarily stored in the memory channel 0 read return buffer 712 and memory channel 1 read return buffer 714 respectively. The circuitry 730 selects a chunk from the buffers 712 and 714 and forwards the selected chunk to a processor (not shown) via a packetized point-to-point interconnect 740. In one embodiment, the circuitry 730 includes a slotter, a multiplexer, and a packetizer.

In one embodiment, each read return is sent in a single packet. The chunks for two read returns sent in two separate packets appear time multiplexed on the interconnect 740. For example, referring to FIG. 7, chunks from memory channel 0 are statically assigned to time slot 0 (710) and chunks from memory channel 1 are statically assigned to time slot 1 (720). In one embodiment, a read chunk from a memory channel is dynamically assigned to the first time slot that is open when the chunk becomes available to be forwarded to the interconnect 740. In one embodiment, the assignment remains valid for the transmission of the entire cache line returned in response to the corresponding read. In one embodiment, the idle/busy state of time slots can be maintained in a few bits, which may be updated when new assignments are made and a read transmission completes. Furthermore, it should be appreciated that the flit size may not be equal to the chunk size. If the flit size is larger than the chunk size, the memory controller hub may wait for more data chunk(s) from the memory channels before forming a flit. Alternatively, if the flit size is smaller than the chunk size, more flits are sent for each data chunk.

The technique disclosed can be extended to an exemplary DRAM system with three memory channels as shown in FIGS. 6B and 6C. There may be a three-way overlap between the returning read cache lines 2010-2030 from each of the three memory channels. The exemplary system runs on a memory clock signal 2005. The flit clock frequency may be a multiple of the frequency of the memory clock signal 2005. Each returning read is assigned a time slot and is sent in the assigned time slot. If there is no data returning in a time slot, the time slot may be left empty.

In one embodiment, the flit clock frequency is three times the frequency of the memory clock signal 2005. Referring to FIG. 6B, the two time slots between the flits 2011 and 2012 are left empty because the cache lines 2020 or 2030 have not arrived yet. Same rule applies to the header flit number 2009 and the first data flit 2011 of the first data return. In contrast, one of the two time slots between the flits 2012 and 2013 is assigned to the header 2029 of the cache line 2020 as the first chunk of the cache line 2020 is arriving. The other time slot between the flits 2012 and 2013 is left empty because the cache line 2030 has not arrived yet. The two time slots between the flits 2014 and 2015 are assigned to the header 2039 of the cache line 2030 and the flit 2022, which contains the second chunk of the cache line 2020.

In one embodiment, the flit clock frequency is twice the frequency of the memory clock signal 2005. Referring to FIG. 6C, during the two time slots between the flits 2011 and 2012, which contain the first and second chunks of the cache line 2010, respectively, the header 2029 of the cache line 2020 is sent in the first time slot and the second time slot is left empty because the cache line 2030 has not returned yet. However, during the two time slots between the flits 2012 and 2013, which contain the second and third chunks of the cache line 2010, respectively, the flit 2021 containing the first chunk of the cache line 2020 and the header 2039 of the cache line 2030 are sent in turn. Likewise, during the time slots between the flits 2013 and 2014, which contain the third and fourth chunks of the cache line 2010, respectively, the flits 2022 and 2031 containing the second chunk of the cache line 2020 and the first chunk of the cache line 2030, respectively, are sent in turn.

Referring to FIG. 6C, the header 2019 of the first cache line 2010 may be sent before the first cache line 2010 starts to arrive, as opposed to the header 2009 in FIG. 6B. Likewise, the header 2029 of the second cache line 2020 may also be sent before the second cache line 2020 starts to arrive. The headers (e.g., headers 2019, 2029, etc.) may be sent before the data chunks of the corresponding cache lines arrive because the memory controller can identify when the first data chunk will arrive so as to send the header beforehand.

An alternate embodiment of a flit-level interleaving in a three-memory channel system is shown in FIG. 6D. The interleaving of flits is performed dynamically instead of statically as shown in FIGS. 6B and 6C. In static interleaving, the flits are interleaved between fixed time intervals. For instance, referring to FIG. 6C, a time gap exists between the sixth flit 2036 of the cache line 2030 and the eighth flit 2028 of the cache line 2020 because the eighth flit 2028 of the cache line 2020 is sent at a fixed time after sending the seventh flit of the cache line 2020. In contrast, referring to FIG. 6D, the flit 2028 is sent between the flits 2036 and 2037 in order to take advantage of the time gap that would otherwise be left empty as the flits containing chunks of the cache line 2010 have all been sent already. Likewise, the flit 2038 is sent in the time slot right after the time slot assigned to the flit 2037. Dynamic interleaving requires tagging the header and data flits so that the receiver may distinguish which occupies a flit. As illustrated by the example in FIG. 6D, dynamic interleaving can provide more efficient data transfer than static interleaving. However, the implementation of static interleaving may be simpler than dynamic interleaving.

In general, some embodiments of flit-interleaving are based on a fixed time slot reservation algorithm which can be applied to a system with arbitrary number of memory channels. For a system with n memory channels, the interconnect is divided into time slots equal to the period of time to send a flit and time slots are assigned in a round robin fashion amongst all n channels. The time slots are assigned based on the order in which the n channels have data ready to send after the interconnect has been idle. The first channel to have data ready to send after the interconnect has been idle is assigned the next available time slot, say slot i, and every nth timeslot after that, i.e. every slot i, i+n, i+2n, . . . until the interconnect is idle once again. Once the interconnect is non-idle, the second channel to have data ready to send is assigned the next available slot that is not already assigned. Supposing that this is slot j, then the second channel is assigned time slots j, j+n, j+2n, . . . where j!=i. Similarly, once the interconnect is non-idle, the rth channel to have data ready to send is assigned the next available slot that is not already assigned to the 1^{st}, 2^{nd}, . . . , r−1 channels to be assigned time slots. Supposing that this is slot k, then the rth channel is assigned time slots k, k+n, k+2n, . . . . where k!=j, k!=i, etc For fixed interleaving these time slots assignments remain in effect until no channel has any data to send, at which time the interconnect becomes idle. Once the interconnect becomes non-idle again, the time slots may be reassigned by the same procedure. For dynamic interleaving, such as shown in FIG. 6D, the rotation of time slot ownership amongst channels is modulo the number of channels that have data ready to send, rather than modulo n. Whenever a channel changes from not ready to ready to send data or from ready to not ready to send data, the time slot ownership from that point on is changed to accommodate either one more or one less, respectively, channel in the round-robin ownership. The receiver can detect when such changes occur based on bits that distinguish header flits from data flits, the number of flits in a packet, and the channel assignment contained in the header.

Furthermore, the technique disclosed can be readily extended to an exemplary DRAM system with four memory channels. In one embodiment, the time axis is divided into the same number of time slots as the number of memory channels in the system. For instance, the time axis may be divided into four time slots when there are four memory channels in the system. However, the time axis in some embodiments may not be divided into the same number of time slots as the number of memory channels. One should appreciate that the technique disclosed is not limited to any particular number of memory channels available in an interleaved memory system. The concept can be applied to systems with a larger number of channels by increasing the speed of the interconnect relative to the memory channel speed. In general, it is easier to increase the interconnect speed than the memory channel speed.

Furthermore, in one embodiment, the transfer of a read packet header is started after receiving the first chunk for the corresponding read from a storage device. Alternatively, the storage device sends an indication to the MCH earlier so that the MCH can send a header for that read one flit clock cycle before the critical chunk is sent on the interconnect. This approach saves a flit latency for the read return as shown by comparing the cache line 630 with the cache line 660 in FIG. 5B.

The foregoing discussion merely describes some exemplary embodiments of the present invention. One skilled in the art will readily recognize from such discussion, the accompanying drawings and the claims that various modifications can be made without departing from the spirit and scope of the appended claims. The description is thus to be regarded as illustrative instead of limiting.

1. A method comprising:
packing a cache line of each of a plurality of read data returns into one or more packets;
splitting each of the one or more packets into a plurality of flits; and
interleaving the plurality of flits of each of the plurality of read data returns.

2. The method of claim 1, further comprising sending the interleaved flits via a packetized interconnect.

3. The method of claim 1, further comprising receiving the plurality of read data returns from a plurality of memory channels in a substantially overlapped manner.

4. The method of claim 3, wherein a critical chunk of an oldest read data return in a queue is sent in one or more first flits and a critical chunk of a second oldest read data return in the queue is sent in one or more second flits.

5. The method of claim 3, further comprising:
adding a header to each of the plurality of read data returns; and
sending the header before each of the plurality of read data returns.

6. An apparatus comprising:
a first buffer to temporarily hold a first cache line of a first read data return;
a second buffer to temporarily hold a second cache line of a second read data return; and
a multiplexer coupled to the first and second buffers to interleave a first and a second pluralities of flits of the first and second cache lines, respectively.

7. The apparatus of claim 6, further comprising an interface to output the interleaved flits in two packets.

8. The apparatus of claim 7, wherein the multiplexer time-multiplexes the first and the second pluralities of flits in a plurality of time slots to interleave the first and second pluralities of flits.

9. The apparatus of claim 8, wherein the multiplexer dynamically time-multiplexes the first and the second pluralities of flits.

10. The apparatus of claim 8, wherein the multiplexer statically time-multiplexes the first and the second pluralities of flits.

11. The apparatus of claim 7, wherein the interleaved flits are sent via a packetized interconnect to a processor.

12. The apparatus of claim 11, wherein a critical chunk of the first read data return is sent in one or more flits of the first plurality of flits and a critical chunk of the second read data return is sent in one or more flits of the second plurality of flits.

13. The apparatus of claim 6, wherein a header is added to each of the first and second cache lines.

14. The apparatus of claim 11, wherein the header is sent after the corresponding read data return starts arriving at one of the first and the second buffers.

15. The apparatus of claim 11, wherein the header is sent before the corresponding read data return starts arriving at one of the first and the second buffers.

16. The apparatus of claim 6, wherein the first and second read data returns arrive from a first memory channel and a second memory channel, respectively, in a substantially overlapped manner.

17. The apparatus of claim 6, further comprising:
a third buffer, coupled to the multiplexer, to temporarily hold a third cache line of a third read data return, wherein the multiplexer interleaves a third plurality of flits of the third cache line with the first and second pluralities of flits.

18. The apparatus of claim 17, further comprising:
a fourth buffer, coupled to the multiplexer, to temporarily hold a fourth cache line of a fourth read data return, wherein the multiplexer interleaves a fourth plurality of flits of the fourth cache line with the first, the second, and the third pluralities of flits.

19. A system comprising:
a first plurality of dynamic random access memory (“DRAM”) devices;
a second plurality of DRAM devices;
a DRAM channel coupled to the first plurality of DRAM devices;
a second DRAM channel coupled to the second plurality of DRAM devices; and
a memory controller coupled to the first and second DRAM channels, the memory controller including
a first buffer to temporarily hold a first cache line of a first read data return from the first DRAM channel;
a second buffer to temporarily hold a second cache line of a second read data return from the second DRAM channel; and
a multiplexer coupled to the first and second buffers to interleave flits of the first and second cache lines.

20. The system of claim 19, wherein the memory controller sends the interleaved flits in two packets.

21. The system of claim 20, wherein the multiplexer time-multiplexes the first and the second pluralities of flits in a plurality of time slots to interleave the first and second pluralities of flits.

22. The system of claim 21, wherein the multiplexer dynamically time-multiplexes the first and the second pluralities of flits.

23. The system of claim 21, wherein the multiplexer statically time-multiplexes the first and the second pluralities of flits.

24. The system of claim 20, further comprising a packetized interconnect coupled to the memory controller to send the interleaved flits.

25. The system of claim 19, wherein a critical chunk of each of the first and second read data returns is sent in one or more flits.

26. The system of claim 19, wherein the memory controller receives the first and second read data returns in a substantially overlapped manner.

27. The system of claim 19, further comprising a processor coupled to the memory controller to receive the interleaved flits of the first and second cache lines.

28. The system of claim 27, wherein the processor comprises a demultiplexer to separate the flits received.

29. The system of claim 19, further comprising:
a third plurality of DRAM devices; and
a third DRAM channel coupled to the third plurality of DRAM devices and the memory controller, wherein the memory controller further includes:
a third buffer, coupled to the multiplexer, to temporarily hold a third cache line of a third read data return from the third DRAM channel, wherein the multiplexer interleaves a third plurality of flits of the third cache line with the first and second pluralities of flits.

30. The system of claim 29, further comprising:
a fourth plurality of DRAM devices; and
a fourth DRAM channel coupled to the fourth plurality of DRAM devices and the memory controller, wherein the memory controller further includes:
a fourth buffer, coupled to the multiplexer, to temporarily hold a fourth cache line of a fourth read data return from the fourth DRAM channel, wherein the multiplexer interleaves a fourth plurality of flits of the fourth cache line with the first, the second, and the third pluralities of flits.

31. A method comprising:
interleaving a plurality of flits containing a critical chunk of each of a first and a second cache lines corresponding to a first and a second read data returns, respectively;
sending the interleaved flits; and
sending a second plurality of flits containing the first cache line's non-critical chunks after the interleaved flits are sent.

32. The method of claim 31, further comprising:
sending a third plurality of flits containing the second cache line's non-critical chunks after the second plurality of flits are sent.

33. The method of claim 32, wherein the first and second read data returns are from a first and a second memory channels, respectively.

34. The method of claim 31, further comprising:
receiving the first and the second read data returns in a substantially overlapped manner.

35. A method comprising:
interleaving a plurality of flits containing a critical chunk of each of a first, a second, and a third cache lines corresponding to a first, a second, and a third read data returns, respectively;
sending the interleaved flits; and
sending a second plurality of flits containing the first cache line's non-critical chunks after the interleaved flits are sent.

36. The method of claim 35, further comprising:
sending a third plurality of flits containing the second cache line's non-critical chunks after the second plurality of flits are sent; and
sending a fourth plurality of flits containing the third cache line's non-critical chunks after the third plurality of flits are sent.

37. The method of claim 36, wherein the first, the second, and the third read data returns are from a first, a second, and a third memory channels, respectively.

38. The method of claim 35, further comprising:
receiving the first, the second, and the third read data returns in a substantially overlapped manner.

39. A method comprising:
interleaving a plurality of flits containing a critical chunk of each of a first, a second, a third, and a fourth cache lines corresponding to a first, a second, a third and a fourth read data returns, respectively;
sending the interleaved flits; and
sending a second plurality of flits containing the first cache line's non-critical chunks after the interleaved flits are sent.

40. The method of claim 39, further comprising:
sending a third plurality of flits containing the second cache line's non-critical chunks after the second plurality of flits are sent;
sending a fourth plurality of flits containing the third cache line's non-critical chunks after the third plurality of flits are sent; and
sending a fifth plurality of flits containing the fourth cache line's non-critical chunks after the fourth plurality of flits are sent.

41. The method of claim 40, wherein the first, the second, the third, and the fourth read data returns are from a first, a second, a third, and a fourth memory channels, respectively.

42. The method of claim 39, further comprising:
receiving the first, the second, the third, and the fourth read data returns in a substantially overlapped manner.

43. A method comprising:
checking whether a buffer holds a critical chunk of a cache line of an oldest read return in a queue;
sending the critical chunk if the buffer holds the critical chunk;
checking whether a predetermined number of non-critical chunks of the cache line have accumulated in the buffer after the critical chunk is sent; and
sending the non-critical chunks if the predetermined number of non-critical chunks have accumulated in the buffer.

44. The method of claim 43, further comprising:
removing the oldest read return from the queue after sending the non-critical chunks.

45. The method of claim 44, wherein the critical chunk and the non-critical chunks are sent via a packetized interconnect.
